(19) United States
(12) Patent Application Publication
(10) Pub. No.: US 2010/0058903 A1
(43) Pub. Date: Mar. 11, 2010

(54) MULTIPLE-SPINDLE TURNING MACHINE HAVING WORKPIECE SUPPORTING SPINDLES MOVABLE IN THE DIRECTION OF THE LONGITUDINAL AXIS OF THE MACHINE

(75) Inventors: Franco RIGOLONE, Ponteranica (IT); Enrico PERSICO, Alzano Lombardo (IT); Renato ROTA, Carvico (IT)

Correspondence Address: Kirschstein, Israel, Schiffmiller & Pieroni, P.C., 425 FIFTH AVENUE, 5TH FLOOR, NEW YORK, NY, 10016-2223, US

(73) Assignee: GILDEMEISTER ITALIANA S.P.A, Brembate Sopra (IT)

(21) Appl. No.: 12/552,524

(22) Filed: Sep. 2, 2009

(30) Foreign Application Priority Data
Sep. 11, 2008 (IT) MI2008A-001622

(51) Int. Cl. B23Q 39/00; B23B 3/30

(52) U.S. Cl. 82/129

(57) ABSTRACT

A multiple-spindle turning machine has an upright structure supporting a rotary drum which, in turn, supports a plurality of workpiece supporting spindles. On the upright, at each spindle, a cross slide adapted to support a plurality of machining tools to be used for machining the front portion of a workpiece is provided.

The machine tool further comprises, in front of the rotary drum, parallel guides which are arranged crosswise of the machine bed, on the guides being slidably mounted two slides each including a workpiece supporting spindle.

On the two sides of the machine tool, near each spindle, a vertical slide adapted to support a plurality of machining tools for machining the rear portion of the workpiece is arranged.

### BACKGROUND OF THE INVENTION

The present invention relates to a multiple-spindle turning machine, including workpiece machining assemblies both on the front and on the rear sides thereof.

Prior multiple-spindle turning machines of the above mentioned type conventionally comprise a large-size drum which can be controllably rotatively driven to bring the individual spindles to a workpiece machining angular position, said rotary drum is is supporting a plurality of built-in spindles rotatively driving the workpieces for machining them by machining tools supported by cross slides mounted on the rotary drum supporting machine structure.

Prior cross slides, supporting the machining tools at said spindles, may be driven both along an X axis radially extending of the drum and along a Z axis longitudinally extending of said rotary drum.

To perform on the workpieces additional machining operations, in the direction of their tangential Y axes, it was necessary in the past to provide on the multiple-spindle turning machine with further mechanical assemblies of a comparatively large size, thereby greatly reducing the machine tool working region, and rendering the machine adjusting operations very long and complex; thus the turning machine will have an insufficient operating flexibility.

A typical further technical drawback of prior multiple-spindle machine tools is that only the workpiece cutting position is available thereon for machining the workpiece rear portion thereby the machining operations must be necessarily very simple and quick, to fit the machine operating time cycle.

For solving the above problems, prior methods greatly modified the machine tool structure to include therein a plurality of working places for machining the workpiece rear parts; alternatively a working platform including two series-coupled machine tools and a handling robot arrangement for monitoring the transfer of half-finished workpieces from a machine to the other has been also prepared.

Another drawback of prior multiple-spindle machines is that the lengths of the workpieces made by said machines are necessarily very small because of damaging flexures the workpieces would be subjected to as they are machined, thereby preventing proper tolerances from being achieved on each finished workpiece. Moreover, because of the available very restricted working region, it is also very difficult to properly unload the machined workpieces.

### SUMMARY OF THE INVENTION

Accordingly, the main object of the present invention is to overcome the above mentioned drawbacks of the prior art, and provide a multiple-spindle machine tool in which the space encompassing the rotary drum near the spindles is not occupied by additional fittings, thereby allowing, in a single multiple-spindle machine tool, to machine workpieces both on the front and on the rear sides and through a comparatively large length thereof, even if said workpieces are very slender. According to the present invention, the above mentioned object is achieved by a multiple-spindle turning machine having a upright machine supporting structure, rotatably supporting a drum bearing a plurality of workpiece supporting spindles, wherein the machine upright supports, at said spindles, cross slides supporting a plurality of machining tools for machining front end portions of the workpieces, and wherein, in the front of a rotary drum supporting platform, parallel guides arranged transversely of the machine bed are provided, said parallel guides supporting cross slides each including a workpiece spindle, and wherein to each of said workpiece spindle is operatively coupled a tool supporting element installed on a vertically movable slide and including tools for machining a rear portion of the workpiece.

Further advantages will better appear from the dependent claims, the following disclosure and accompanying drawings.

### BRIEF DESCRIPTION OF THE DRAWINGS

The present invention will be disclosed in a more detailed manner hereinafter, with reference to a multiple-spindle machine tool, given only by way of an example.

In the accompanying drawings:

FIG. 1 shows the rotary drum of the multiple-spindle turning machine with the related spindles and machining tool supporting slides supported by the machine structure;

FIG. 2 is a perspective view showing the rotary drum of the multiple-spindle machine, with the workpiece taking means for taking the workpiece after it has been machined on its front portion;

FIGS. 3 and 4 are perspective views showing the rotary drum and spindles with the driving means for driving the workpieces in two possible configurations, that is with and without a rotary bush;

FIG. 5 is a schematic top plan view showing the multiple-spindle machine;

FIG. 6 is a further perspective view of the multiple-spindle machine;

FIG. 7 is a top plan view of the machine shown in some different machining steps thereof;

FIG. 8 is a further top plan view of the multiple-spindle machine in further machining steps thereof;

FIG. 9 is another top plan view of the multiple spindle machine showing a step for taking a workpiece and a further machining step for machining a rear portion of said workpiece, and

FIG. 10 is yet another top plan view of the machine and workpiece taking devices D therefor.

### DESCRIPTION OF THE PREFERRED EMBODIMENTS

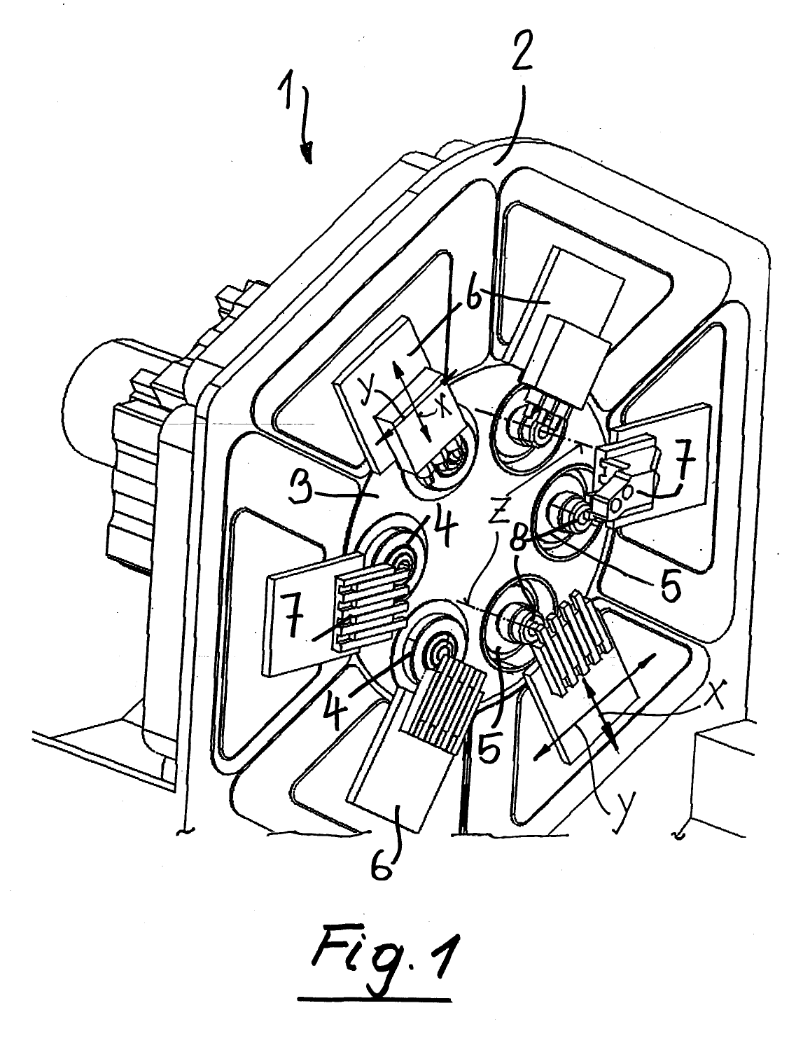

As shown in FIG. 1, the machine according to the present invention has been generally indicated by the reference number 1 and comprises a supporting upright structure 2, on which a per se known controllably rotatively driven drum 3 is rotatably supported.

The drum 3 supports a plurality of workpiece spindles 4 and 5, which will be discussed in a more detailed manner hereinafter. FIGS. 1 shows that the supporting structure or platform 2 supporting said drum 3 also supports cross-slides 6, which are equipped, in a per se known manner, with machining tools generally indicated by 7.

Advantageously, said machining tools 7 can be driven either along a radial axis X and along a tangential axis Y (see FIG. 1).

Such an arrangement allows to use machining tools 7 suitably chosen and arranged to perform machining operations on the front sides or portions of the workpieces, indicated by the reference number 8.

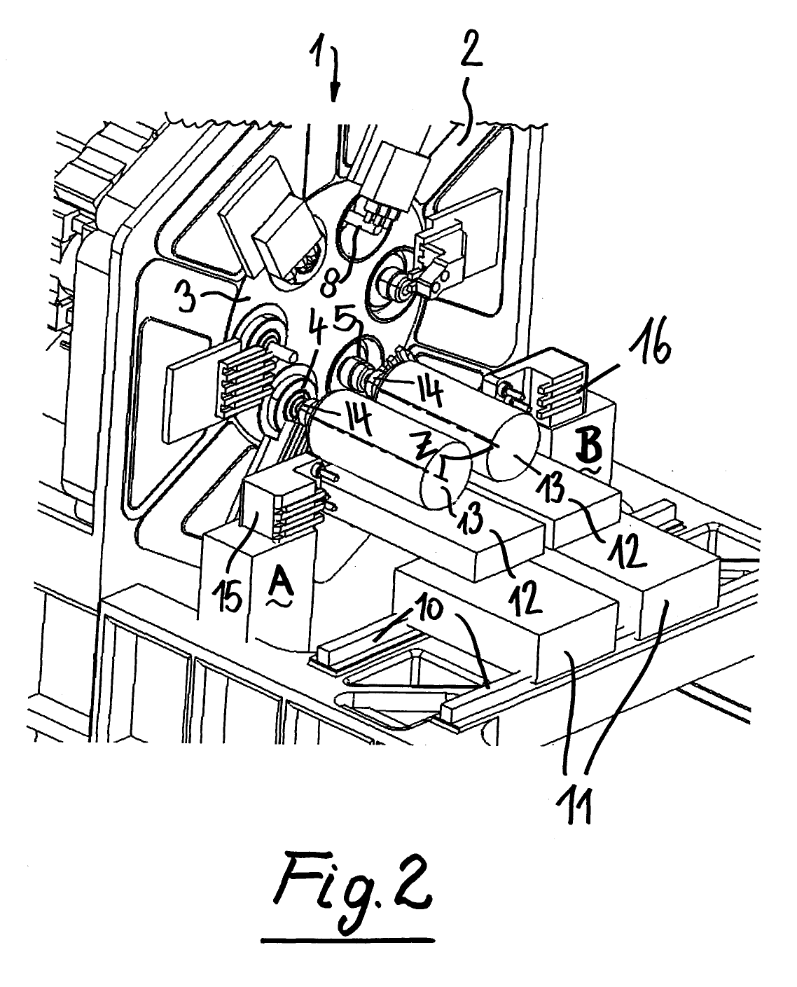

FIG. 2 shows that, on the front of the drum 3 supported on the supporting platform 2 of the machine, the multiple spindle machine structure further supports parallel guides 10 extending transversely of the bed of the machine 1, in a horizontal plane.

The guides 10 support driving carriages 11 which are controllably driven independently, from one another, along said sliding parallel guides 10, and which can be driven by per se known driving systems such as ball recirculating screws and controllable motors or linear motors.

Each carriage 11 supports a slide 12 which is controllably driven along the longitudinal axis Z of the drum 3, each slide 12 supporting individually controllable motors 13 and including grippers for gripping the workpieces 8 from the drum 3 supported spindles 4 and 5.

The multiple-spindle machine 1 further supports machining tool holders 15 and 16 each mounted on corresponding vertically movable slides (A) and (B) which will be disclosed in a more detailed manner hereinafter.

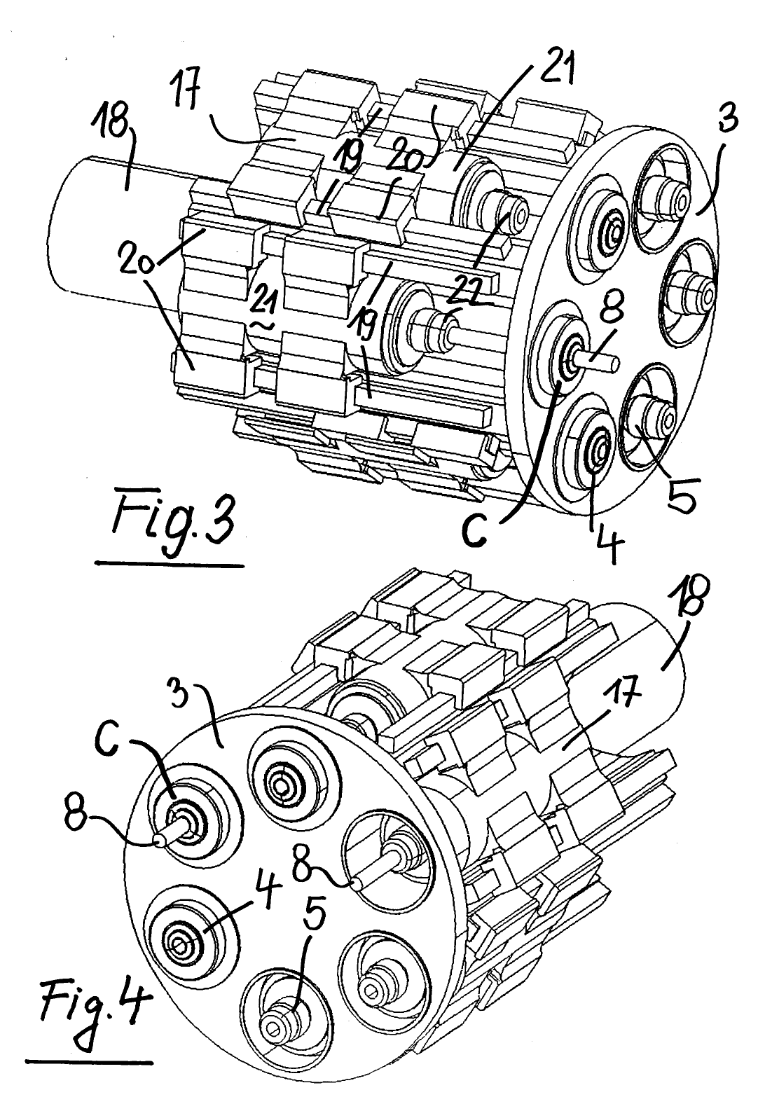

FIGS. 3 and 4 show, by a respective perspective view, the rotary drum 3 with the spindles adapted to be driven in the longitudinal direction of the axis Z of said drum.

The front portion of the drum 3 is integral with the structure 18 supporting, for each workpiece supporting rotary spindle, the parallel guides 19 thereon are slidably mounted skids 20 allowing the workpiece holder spindle 21 to be driven in a longitudinal direction Z of the rotary drum 3 axis.

The workpiece supporting spindle 21, through the gripper 22, rotatively drives the workpiece 8.

The figures show moreover a double configuration of the tool machine.

At the position 5 the machine tool has its basis configuration, in which the spindle rotatively drives the workpiece and displaces the latter in the Z direction, to cause said workpiece to directly project, from a required projection distance, from the front portion of the drum 3, which does not comprise supports. In this case, the workpiece has a small size and is not subjected to bending or flexural movements during its machining operations.

At the position 4, on the contrary, a rotary bush (C) is provided for supporting the great length slender workpiece 8, which a support is necessary for limiting the flexure of the slender workpiece inevitably occurring during the machining operations on the slides 6 of FIG. 1.

The rotary bush can be driven by per se known driving units, such as a mechanical driving unit including a drive shaft, or by a dependent auxiliary motor.

Thus, the two above machine configurations can be achieved from a same basic machine.

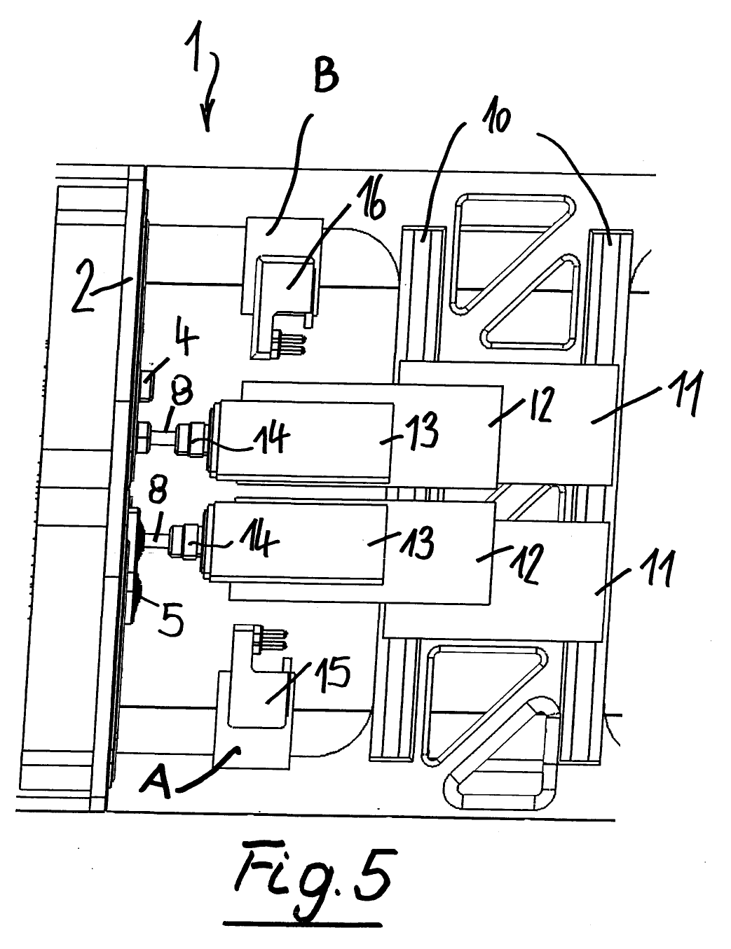

FIG. 5 shows by a top plan view the main parts of the multiple-spindle machine 1.

In this figure it is possible to see the platform or structure 2 supporting the spindles 4 and 5, and the workpieces 8 to be machined.

FIG. 5 also shows the cross parallel guides 10 slidably supporting the carriages 11 supporting the slides 12, in turn supporting the spindles 13 for rotatively driving the grippers 14.

FIG. 5 shows moreover the tool holders 15 and 16 for machining the rear end portions of the workpieces 8, mounted on the vertically movable slides (A) and (B).

Furthermore, FIG. 5 also schematically shows that, at the end of the front machining operation on the workpieces 8, the spindles 13 will be already arranged at the front end portions of said workpieces 8, to be removed by the spindles 4 and 5 after the cutting operation.

Thus, it is possible to carry out, on the same tool machine 1, a machining on the rear sides of the workpieces 8, by using, to that end, the machining tools of the assemblies 15 and 16.

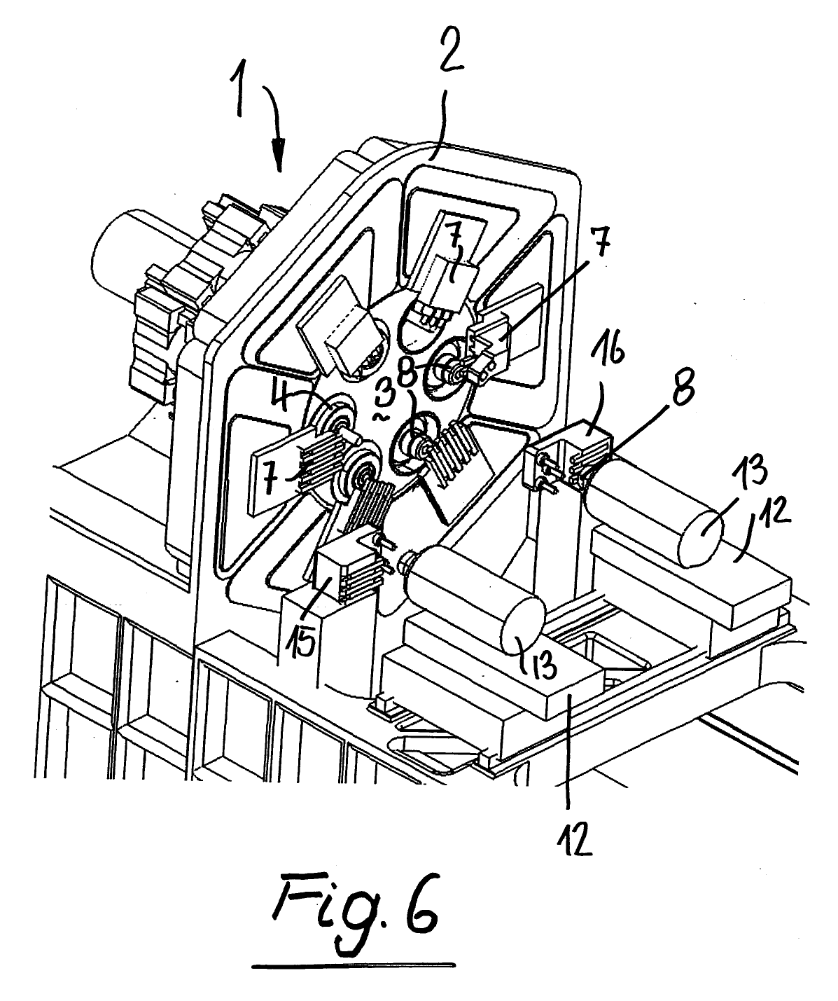

As shown in FIG. 6, the removed workpieces 8 are rotatively driven by the spindles 13 supported on the slide 12 and, owing to the provision of the tool holders 15 and 16, it is possible to cut workpieces 8 even on their rear sides.

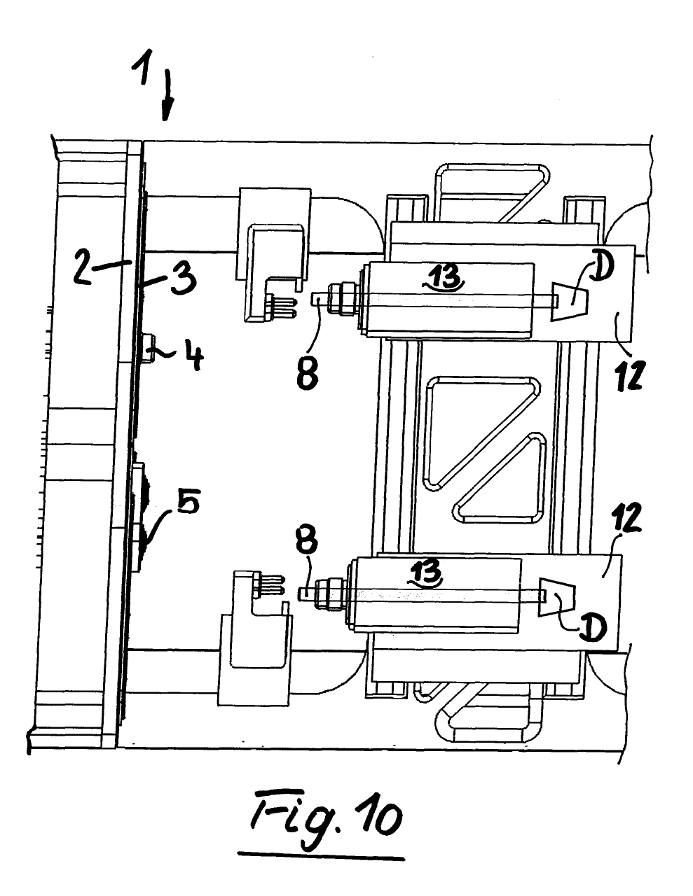

FIG. 10 shows an example illustrating that the subject machine tool also provides a finished large length workpiece 8.

The spindles 13, driven by the slides 12, remove the workpiece 8 from the rotary drum 3 spindles 4 and 5. Upon having machined the rear sides by the tool holders 15 and 16, a driven arm (not shown in the drawing) disengages from the rear part of the spindles 13 the long workpiece 8 by the gripper element (D), see FIG. 10.

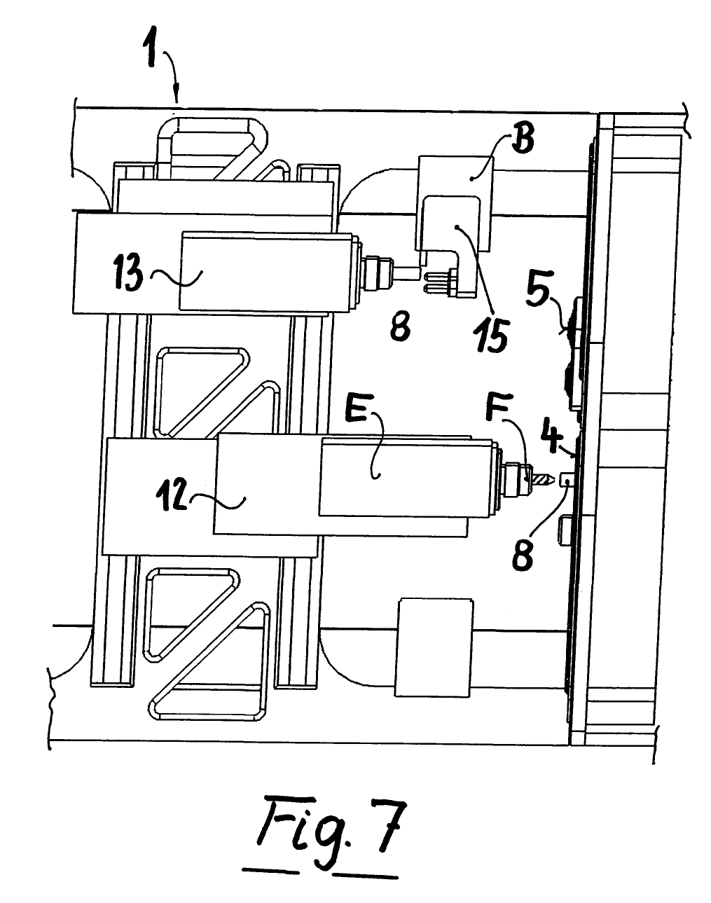

FIG. 7 shows the basic configuration of the multiple-spindle tool machine.

The spindle 13 is herein used for machining the rear side or portion of the workpiece 8 just taken from the mandrel 5, by the tool holder 15 mounted on the vertical slide (B).

The slide 12 further supports a motor (E) for rotatively driving the tool (F) for machining the workpiece 8 in the spindle 4.

In such a configuration, the multiple-spindle assembly will have a single position for machining the workpiece rear side, and another position for machining, by a rotary tool, the workpiece front side.

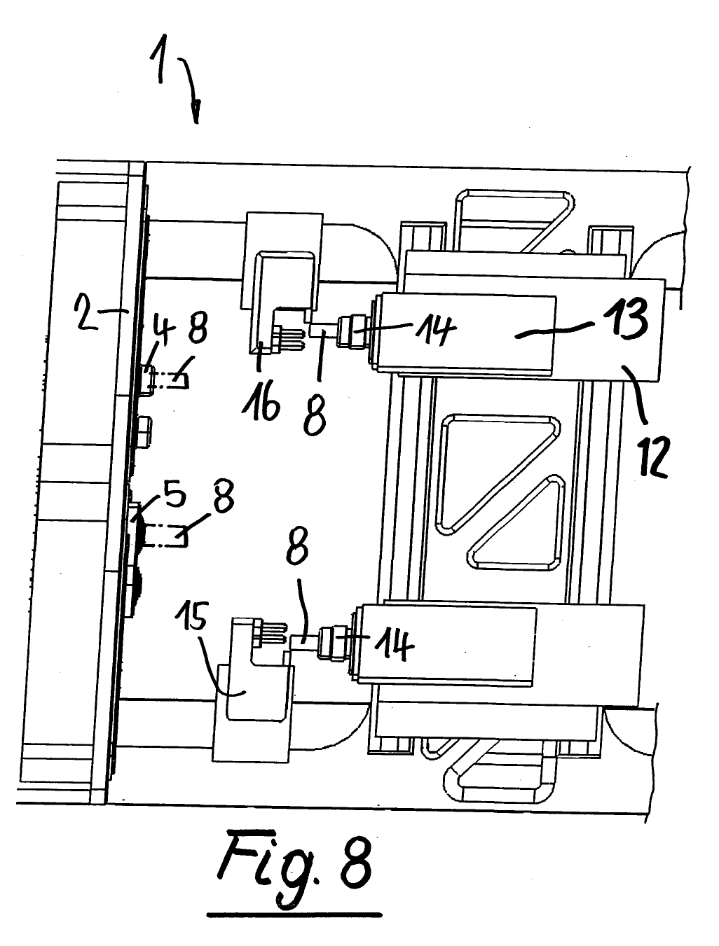

FIG. 8 shows a further configuration or arrangement of the multiple-spindle machine tool.

This arrangement is herein called a “double cycle” arrangement, in which, in particular, said machine tool is programmed to simultaneously make two simple workpieces; the workpiece 8 being made by using three of the six available positions on the rotary drum 3, performing a two-snap displacement rotary movements at a time.

In the last position of the drum 3, the two workpieces 8, with the front machining portion finished thereon, are arranged in the spindles 4 and 5; at this time, the slides 12 will bring the spindles 13 to the workpiece gripping position, and then will be withdrawn up to the tool holders 15 and 16, to machine the rear side of the workpieces 8. At the end of the rear machining operations, the two machined workpieces being simultaneously unloaded.

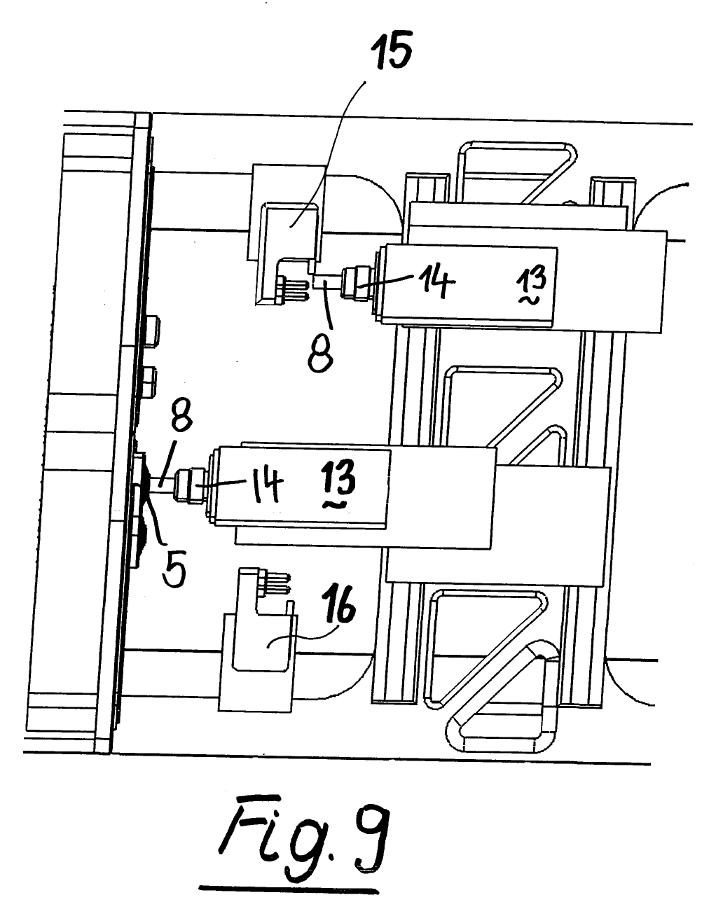

FIG. 9 shows a further configuration or pattern of the multiple-spindle machine tool.

This pattern is herein called a “double recovery” pattern, since, in particular, the machine tool makes in this configuration a workpiece by long processing time rear machining operations.

In particular, the two spindles 13 make the same rear machining operations on the respective tool holders 15 and 16, which machining operations are offset of such a time as to allow the rotary drum 3 to bring the workpiece 8 to its end position 5.

Accordingly, said workpiece 8 is gripped by the two spindles 13, for the rear machining operations. in an alternated manner.

1. A multiple-spindle turning machine (1) having a turning machine upright (2) rotatably supporting a drum (3) bearing a plurality of spindles (4, 5), characterized in that said spindles (4, 5) are movable along a longitudinal axis (Z) with respect to said drum (3).

2. A multiple-spindle turning machine, according to claim 1, characterized in that said upright (2) supports, for each said spindle (4, 5), a cross slide (6) driving a tool bearing assembly (7) respectively in a radial direction (X) and a tangential direction (Y) of said drum (3).

3. A multiple-spindle turning machine, according to claim 1, characterized in that said turning machine comprises, in front of said upright (2), parallel guides (10) arranged transversely of a bed of said turning machine, and slidably supporting cross slides (11, 12), each of which respectively supports a workpiece rotary spindle (13).

4. A multiple-spindle turning machine, according to claim 1, characterized in that said turning machine further comprises on a side of each said spindle (13), vertical slides (A, B) supporting tool holders (15, 16) for machining the rear parts of said workpiece.

5. A multiple-spindle turning machine, according to claim 1, characterized in that, for machining slender workpieces, said rotary drum (3) supports a rotary bush (C) in turn supporting said workpiece being machined while preventing said workpiece from bending.

6. A multiple-spindle turning machine, according to claim 1, characterized in that, for performing standard machining operations, a spindle (13) is replaced by a driving motor (E) for rotatively driving a machining tool (F) for performing front machining operations on the workpiece on the spindle (4).

7. A multiple-spindle turning machine, according to claim 1, characterized in that said spindles (13) are so controlled by a numerical control device to perform “double retooling” machining operations, for machining rear parts of workpieces requiring a long machining operating time.

8. A multiple-spindle turning machine, according to claim 1, characterized in that said spindles (13) are so controlled by said numerical control device as to perform “double cycle” machining operations, for simultaneously producing two simple workpieces.
